(19) United States
(12) Patent Application Publication
(10) Pub. No.: US 2026/0180653 A1
(43) Pub. Date: Jun. 25, 2026

(54) Enhanced Channel State Information Measurement and Reporting at High Movement Speeds

(71) Applicant: Apple Inc., Cupertino, CA (US)

(72) Inventors: Haitong Sun, Saratoga, CA (US); Chunhai Yao, Beijing (CN); Dawei Zhang, Saratoga, CA (US); Wei Zeng, Saratoga, CA (US); Huaning Niu, San Jose, CA (US); Weidong Yang, San Diego, CA (US); Ankit Bhamri, Haar (DE)

(21) Appl. No.: 19/102,194

(22) PCT Filed: Sep. 23, 2022
(86) PCT No.: PCT/CN2022/120868

§ 371 Date: Feb. 7, 2025

(51) Int. Cl. H04B 7/06; H04B 17/309; H04L 5/00; H04W 76/10

(52) U.S. Cl. CPC H04B 7/0626; H04B 17/309; H04L 5/0048; H04W 76/10

(57) ABSTRACT

A base station (BS) may be configured to establish a cellular link with a user equipment (UE) and transmit radio resource control (RRC) signaling including channel state information (CSI) reporting configuration information to the UE. The BS may further transmit at least one burst of one or more CSI reference signals (CSI-RS) to the UE according to the CSI reporting configuration information and receive a first CSI report using time-domain properties of the channel and corresponding to the burst of the one or more CSI-RS. The BS may then determine modified CSI reporting configuration information based on the first CSI report and transmit an adjusted burst of one or more additional CSI-RS to the UE according to the modified CSI reporting configuration information. The BS may then receive, from the UE, an additional CSI report according to the modified CSI reporting configuration information.

### FIELD

The present application relates to wireless devices, and more particularly to apparatus, systems, and methods for enhanced channel state information measurement and reporting at high movement speeds in a wireless communication system.

### DESCRIPTION OF THE RELATED ART

Wireless communication systems are rapidly growing in usage. In recent years, wireless devices such as smart phones and tablet computers have become increasingly sophisticated. In addition to supporting telephone calls, many mobile devices now provide access to the internet, email, text messaging, and navigation using the global positioning system (GPS), and are capable of operating sophisticated applications that utilize these functionalities. Additionally, there exist numerous different wireless communication technologies and standards. Some examples of wireless communication standards include GSM, UMTS (associated with, for example, WCDMA or TD-SCDMA air interfaces), LTE, LTE Advanced (LTE-A), HSPA, 3GPP2 CDMA2000 (e.g., 1×RTT, 1×EV-DO, HRPD, eHRPD), IEEE 802.11 (WLAN or Wi-Fi), BLUETOOTH™, etc.

The ever increasing number of features and functionality introduced in wireless communication devices also creates a continuous need for improvement in both wireless communications and in wireless communication devices. In particular, it is important to ensure the accuracy of transmitted and received signals through wireless devices used in wireless cellular communications. In addition, increasing the functionality of a UE device can place a significant strain on the battery life of the UE device. Thus it is very important to also reduce power requirements in UE device designs while allowing the UE device to maintain good transmit and receive abilities for improved communications.

Additionally, wireless devices are used in an increasing range of contexts. For example, wireless devices may be used at a variety of movement speeds, e.g., ranging from relatively stationary or slow movement speeds (e.g., devices in fixed locations or carried by pedestrians) to very high speeds (e.g., high speed trains (HSTs), etc.). Different techniques and features may provide better performance under different such conditions, at least in some instances. Accordingly, improvements in the field are desired.

### SUMMARY

Embodiments relate to apparatuses, systems, and methods for enhanced channel state information measurement and reporting at high movement speeds in a wireless communication system.

According to some embodiments, a base station (BS) may be configured to establish a cellular link with a user equipment (UE) and transmit radio resource control (RRC) signaling including channel state information (CSI) reporting configuration information to the UE. The BS may further transmit at least one burst of one or more CSI reference signals (CSI-RS) to the UE according to the CSI reporting configuration information and receive a first CSI report using time-domain properties of the channel and corresponding to the burst of the one or more CSI-RS. The BS may then determine modified CSI reporting configuration information based on the first CSI report and transmit an adjusted burst of one or more additional CSI-RS to the UE according to the modified CSI reporting configuration information. The BS may then receive, from the UE, an additional CSI report according to the modified CSI reporting configuration information.

In some embodiments, the CSI reporting configuration information may include at least one of a number of CSI-RS per burst or time domain spacing of the one or more CSI-RS. Additionally or alternatively, the BS may be further configured to modify the CSI reporting configuration information via a media access control—control element (MAC-CE).

According to some scenarios, the one or more CSI-RS may be transmitted such that the one or more CSI-RS are equally spaced in a time-domain, the one or more CSI-RS have the same frequency domain allocation, the one or more CSI-RS have the same number of antenna ports, the one or more CSI-RS are quasi-colocated (QCL), the one or more CSI-RS share a time-domain pattern, and/or the one or more CSI-RS have a same periodicity. The BS may be further configured to transmit, to the UE, an additional burst including one or more additional CSI-RS, wherein the one or more additional CSI-RS are transmitted in a non-overlapping manner with the one or more CSI-RS, according to some embodiments.

In some instances, the first CSI report may include an indication of one or more preferred channel measurement resource (CMR) or interference measurement resources (IMR) configurations. Furthermore and according to some embodiments, the BS may be configured to transmit, to the UE, downlink control information (DCI), wherein the DCI includes at least one of a number of CSI-RS per burst or time domain spacing information corresponding to the burst of the one or more CSI-RS.

According to some embodiments, the one or more CSI-RS may be associated with one or more interference measurement resources (IMRs). Additionally or alternatively, the BS may be configured to transmit, to the UE, downlink control information (DCI), wherein the DCI includes time-domain information corresponding to the burst of the one or more IMRs. In some embodiments, the additional CSI report may include an additional indication of one or more preferred channel measurement resource (CMR) or interference measurement resources (IMR) configurations. Additionally or alternatively, at least one of the first CSI report or additional CSI report may include Doppler shift measurement information.

In some embodiments, a UE may be configured to establish, via a cellular network, a cellular link with a base station (BS). Furthermore, the UE may be configured to receive, from the BS, radio resource control (RRC) signaling including channel state information (CSI) reporting configuration information. The UE may be further configured to receive, according to the CSI reporting configuration information, at least one burst of one or more CSI reference signals (CSI-RS) from the BS. The UE may then transmit, to the BS, a first CSI report according to the CSI reporting configuration, wherein the first CSI report uses time-domain properties of the channel corresponding to the burst of the one or more CSI-RS. Furthermore, the UE may be configured to receive, from the BS, modified CSI reporting configuration information in addition to an adjusted burst of one or more additional CSI-RS according to the modified CSI reporting configuration information. The UE may then transmit, to the BS, an additional CSI report according to the modified CSI reporting configuration information. According to some embodiments, the UE may be further configured to receive, from the BS, an additional burst including one or more additional CSI-RS, wherein the one or more additional CSI-RS are transmitted in a non-overlapping manner with the one or CSI-RS. Additionally or alternatively, the UE may be configured to receive, from the BS, downlink control information (DCI), wherein the DCI includes at least one of a number of CSI-RS per burst or time domain spacing information corresponding to the burst of the one or more CSI-RS.

The techniques described herein may be implemented in and/or used with a number of different types of devices, including but not limited to cellular phones, tablet computers, wearable computing devices, portable media players, and any of various other computing devices.

This Summary is intended to provide a brief overview of some of the subject matter described in this document. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE DRAWINGS

A better understanding of the present subject matter can be obtained when the following detailed description of various embodiments is considered in conjunction with the following drawings, in which:

FIG. 1 illustrates an example wireless communication system, according to some embodiments;

FIG. 2 illustrates a base station (BS) in communication with a user equipment (UE) device, according to some embodiments;

FIG. 3 illustrates an example block diagram of a UE, according to some embodiments;

FIG. 4 illustrates an example block diagram of a BS, according to some embodiments;

FIG. 5 illustrates an example block diagram of cellular communication circuitry, according to some embodiments;

FIG. 6A illustrates an example of connections between an EPC network, an LTE base station (eNB), and a 5G NR base station (gNB), according to some embodiments;

FIG. 6B illustrates an example of a protocol stack for an eNB and a gNB, according to some embodiments;

FIG. 7 is a flowchart diagram illustrating an example method of performing enhanced CSI measurement reporting while moving at high velocities/speeds, according to some embodiments;

FIGS. 8-9 illustrate example channel state information-reference signal (CSI-RS) burst patterns and timing corresponding to channel measurement resource (CMR) configurations, according to some embodiments.

FIG. 10 illustrates an example media access control—control element (MAC-CE) format used to specify CSI-RS burst patterns and timing for CMR configurations, according to some embodiments.

FIG. 11 illustrates an example channel state information-reference signal (CSI-RS) burst pattern and timing corresponding to an interference measurement resource (IMR) configuration, according to some embodiments.

FIG. 12 illustrates an example MAC-CE format used to specify CSI-RS burst patterns and timing for IMR configurations, according to some embodiments.

While the features described herein may be susceptible to various modifications and alternative forms, specific embodiments thereof are shown by way of example in the drawings and are herein described in detail. It should be understood, however, that the drawings and detailed description thereto are not intended to be limiting to the particular form disclosed, but on the contrary, the intention is to cover all modifications, equivalents and alternatives falling within the spirit and scope of the subject matter as defined by the appended claims.

### DETAILED DESCRIPTION

### Acronyms

Various acronyms are used throughout the present disclosure. Definitions of the most prominently used acronyms that may appear throughout the present disclosure are provided below:

3GPP: Third Generation Partnership Project
TS: Technical Specification
RAN: Radio Access Network
RAT: Radio Access Technology
UE: User Equipment
RF: Radio Frequency
BS: Base Station
DL: Downlink
UL: Uplink
LTE: Long Term Evolution
NR: New Radio
5GS: 5G System
5GMM: 5GS Mobility Management
5GC: 5G Core Network
IE: Information Element
RRC: Radio Resource Control
HST: High Speed Train
SFN: Single Frequency Network
TRP: Transmission and Reception Point
MAC-CE: Media Access Control - Control Element
TCI: Transmission Configuration Indicator
CORESET: Control Resource Set
CSI-RS: Channel State Information - Reference Signal
CC: Component Carrier
RACH: Random Access Channel
RLC: Radio Link Control
NW: Network
UE: User Equipment
SI: System Information
SIB1: System Information Block - 1
SSB: Synchronization Signal Block
PDCCH: Physical Downlink Control Channel
PUSCH: Physical Uplink Shared Channel
BWP: Bandwidth Part
RB: Resource Block
DCI: Downlink Control Information
ID: Identifier
QCL: Quasi-Co-Located or Quasi-Co-Location
CSI: Channel State Information
CQI: Channel Quality Indicator
PMI: Precoding Matrix Indicator
RI: Rank Indicator
CMR: Channel Measurement Resource
IMR: Interference Measurement Resource
MIMO: Multiple Input Multiple Output
SP: Semi-persistent
AP: Aperiodic
ZP: Zero Power
NZP: Non-Zero Power

### Terms

The following is a glossary of terms used in this disclosure:

Memory Medium—Any of various types of non-transitory memory devices or storage devices. The term “memory medium” is intended to include an installation medium, e.g., a CD-ROM, floppy disks, or tape device; a computer system memory or random access memory such as DRAM, DDR RAM, SRAM, EDO RAM, Rambus RAM, etc.; a non-volatile memory such as a Flash, magnetic media, e.g., a hard drive, or optical storage; registers, or other similar types of memory elements, etc. The memory medium may include other types of non-transitory memory as well or combinations thereof. In addition, the memory medium may be located in a first computer system in which the programs are executed, or may be located in a second different computer system which connects to the first computer system over a network, such as the Internet. In the latter instance, the second computer system may provide program instructions to the first computer for execution. The term “memory medium” may include two or more memory mediums which may reside in different locations, e.g., in different computer systems that are connected over a network. The memory medium may store program instructions (e.g., embodied as computer programs) that may be executed by one or more processors.

Carrier Medium—a memory medium as described above, as well as a physical transmission medium, such as a bus, network, and/or other physical transmission medium that conveys signals such as electrical, electromagnetic, or digital signals.

Programmable Hardware Element—includes various hardware devices comprising multiple programmable function blocks connected via a programmable interconnect. Examples include FPGAs (Field Programmable Gate Arrays), PLDs (Programmable Logic Devices), FPOAs (Field Programmable Object Arrays), and CPLDs (Complex PLDs). The programmable function blocks may range from fine grained (combinatorial logic or look up tables) to coarse grained (arithmetic logic units or processor cores). A programmable hardware element may also be referred to as “reconfigurable logic”.

Computer System—any of various types of computing or processing systems, including a personal computer system (PC), mainframe computer system, workstation, network appliance, Internet appliance, personal digital assistant (PDA), television system, grid computing system, or other device or combinations of devices. In general, the term “computer system” can be broadly defined to encompass any device (or combination of devices) having at least one processor that executes instructions from a memory medium.

User Equipment (UE) (or “UE Device”)—any of various types of computer systems devices which are mobile or portable and which performs wireless communications. Examples of UE devices include mobile telephones or smart phones (e.g., iPhone™, Android™-based phones), portable gaming devices (e.g., Nintendo DS™, PlayStation Portable™, Gameboy Advance™, iPhone™), laptops, wearable devices (e.g. smart watch, smart glasses), PDAs, portable Internet devices, music players, data storage devices, or other handheld devices, etc. In general, the term “UE” or “UE device” can be broadly defined to encompass any electronic, computing, and/or telecommunications device (or combination of devices) which is easily transported by a user and capable of wireless communication.

Base Station—The term “Base Station” has the full breadth of its ordinary meaning, and at least includes a wireless communication station installed at a fixed location and used to communicate as part of a wireless telephone system or radio system.

Processing Element—refers to various elements or combinations of elements that are capable of performing a function in a device, such as a user equipment or a cellular network device. Processing elements may include, for example: processors and associated memory, portions or circuits of individual processor cores, entire processor cores, processor arrays, circuits such as an ASIC (Application Specific Integrated Circuit), programmable hardware elements such as a field programmable gate array (FPGA), as well any of various combinations of the above.

Channel—a medium used to convey information from a sender (transmitter) to a receiver. It should be noted that since characteristics of the term “channel” may differ according to different wireless protocols, the term “channel” as used herein may be considered as being used in a manner that is consistent with the standard of the type of device with reference to which the term is used. In some standards, channel widths may be variable (e.g., depending on device capability, band conditions, etc.). For example, LTE may support scalable channel bandwidths from 1.4 MHz to 20 MHz. In contrast, WLAN channels may be 22 MHz wide while Bluetooth channels may be 1 Mhz wide. Other protocols and standards may include different definitions of channels. Furthermore, some standards may define and use multiple types of channels, e.g., different channels for uplink or downlink and/or different channels for different uses such as data, control information, etc.

Band—The term “band” has the full breadth of its ordinary meaning, and at least includes a section of spectrum (e.g., radio frequency spectrum) in which channels are used or set aside for the same purpose.

Automatically—refers to an action or operation performed by a computer system (e.g., software executed by the computer system) or device (e.g., circuitry, programmable hardware elements, ASICs, etc.), without user input directly specifying or performing the action or operation. Thus the term “automatically” is in contrast to an operation being manually performed or specified by the user, where the user provides input to directly perform the operation. An automatic procedure may be initiated by input provided by the user, but the subsequent actions that are performed “automatically” are not specified by the user, i.e., are not performed “manually”, where the user specifies each action to perform. For example, a user filling out an electronic form by selecting each field and providing input specifying information (e.g., by typing information, selecting check boxes, radio selections, etc.) is filling out the form manually, even though the computer system must update the form in response to the user actions. The form may be automatically filled out by the computer system where the computer system (e.g., software executing on the computer system) analyzes the fields of the form and fills in the form without any user input specifying the answers to the fields. As indicated above, the user may invoke the automatic filling of the form, but is not involved in the actual filling of the form (e.g., the user is not manually specifying answers to fields but rather they are being automatically completed). The present specification provides various examples of operations being automatically performed in response to actions the user has taken.

Approximately—refers to a value that is almost correct or exact. For example, approximately may refer to a value that is within 1 to 10 percent of the exact (or desired) value. It should be noted, however, that the actual threshold value (or tolerance) may be application dependent. For example, in some embodiments, “approximately” may mean within 0.1% of some specified or desired value, while in various other embodiments, the threshold may be, for example, 2%, 3%, 5%, and so forth, as desired or as required by the particular application.

Concurrent—refers to parallel execution or performance, where tasks, processes, or programs are performed in an at least partially overlapping manner. For example, concurrency may be implemented using “strong” or strict parallelism, where tasks are performed (at least partially) in parallel on respective computational elements, or using “weak parallelism”, where the tasks are performed in an interleaved manner, e.g., by time multiplexing of execution threads.

Various components may be described as “configured to” perform a task or tasks. In such contexts, “configured to” is a broad recitation generally meaning “having structure that” performs the task or tasks during operation. As such, the component can be configured to perform the task even when the component is not currently performing that task (e.g., a set of electrical conductors may be configured to electrically connect a module to another module, even when the two modules are not connected). In some contexts, “configured to” may be a broad recitation of structure generally meaning “having circuitry that” performs the task or tasks during operation. As such, the component can be configured to perform the task even when the component is not currently on. In general, the circuitry that forms the structure corresponding to “configured to” may include hardware circuits.

Various components may be described as performing a task or tasks, for convenience in the description. Such descriptions should be interpreted as including the phrase “configured to.” Reciting a component that is configured to perform one or more tasks is expressly intended not to invoke 35 U.S.C. § 112(f) interpretation for that component.

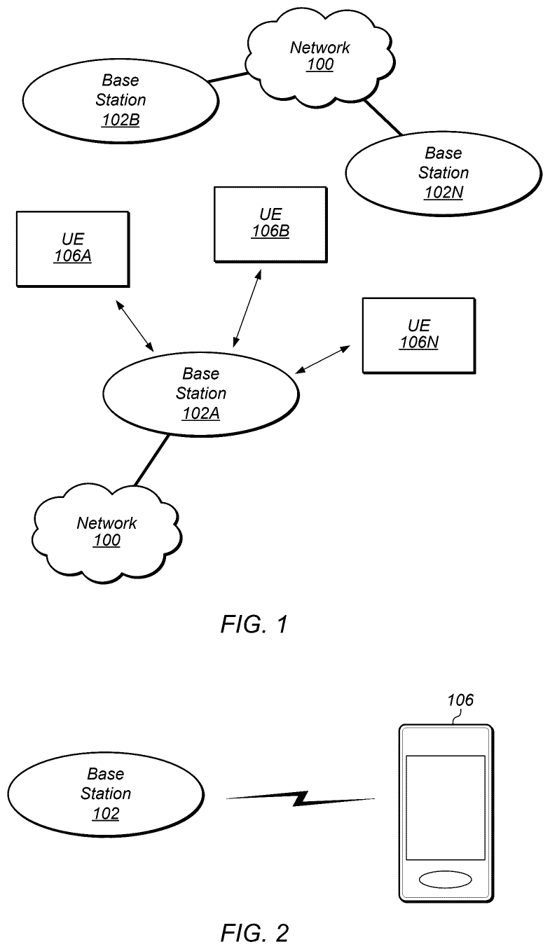

### FIGS. 1 and 2—Communication System

FIG. 1 illustrates a simplified example wireless communication system, according to some embodiments. It is noted that the system of FIG. 1 is merely one example of a possible system, and that features of this disclosure may be implemented in any of various systems, as desired.

As shown, the example wireless communication system includes a base station 102A which communicates over a transmission medium with one or more user devices 106A, 106B, etc., through 106N. Each of the user devices may be referred to herein as a “user equipment” (UE). Thus, the user devices 106 are referred to as UEs or UE devices.

The base station (BS) 102A may be a base transceiver station (BTS) or cell site (a “cellular base station”), and may include hardware that enables wireless communication with the UEs 106A through 106N.

The communication area (or coverage area) of the base station may be referred to as a “cell.” The base station 102A and the UEs 106 may be configured to communicate over the transmission medium using any of various radio access technologies (RATs), also referred to as wireless communication technologies, or telecommunication standards, such as GSM, UMTS (associated with, for example, WCDMA or TD-SCDMA air interfaces), LTE, LTE-Advanced (LTE-A), 5G new radio (5G NR), HSPA, 3GPP2 CDMA2000 (e.g., 1×RTT, 1×EV-DO, HRPD, eHRPD), etc. Note that if the base station 102A is implemented in the context of LTE, it may alternately be referred to as an ‘eNodeB’ or ‘eNB’. Note that if the base station 102A is implemented in the context of 5G NR, it may alternately be referred to as ‘gNodeB’ or ‘gNB’.

As shown, the base station 102A may also be equipped to communicate with a network 100 (e.g., a core network of a cellular service provider, a telecommunication network such as a public switched telephone network (PSTN), and/or the Internet, among various possibilities). Thus, the base station 102A may facilitate communication between the user devices and/or between the user devices and the network 100. In particular, the cellular base station 102A may provide UEs 106 with various telecommunication capabilities, such as voice, SMS and/or data services.

Base station 102A and other similar base stations (such as base stations 102B . . . 102N) operating according to the same or a different cellular communication standard may thus be provided as a network of cells, which may provide continuous or nearly continuous overlapping service to UEs 106A-N and similar devices over a geographic area via one or more cellular communication standards.

Thus, while base station 102A may act as a “serving cell” for UEs 106A-N as illustrated in FIG. 1, each UE 106 may also be capable of receiving signals from (and possibly within communication range of) one or more other cells (which might be provided by base stations 102B-N and/or any other base stations), which may be referred to as “neighboring cells”. Such cells may also be capable of facilitating communication between user devices and/or between user devices and the network 100. Such cells may include “macro” cells, “micro” cells, “pico” cells, and/or cells which provide any of various other granularities of service area size. For example, base stations 102A-B illustrated in FIG. 1 might be macro cells, while base station 102N might be a micro cell. Other configurations are also possible.

In some embodiments, base station 102A may be a next generation base station, e.g., a 5G New Radio (5G NR) base station, or “gNB”. In some embodiments, a gNB may be connected to a legacy evolved packet core (EPC) network and/or to a NR core (NRC) network.

In addition, a gNB cell may include one or more transition and reception points (TRPs). In addition, a UE capable of operating according to 5G NR may be connected to one or more TRPs within one or more gNBs.

Note that a UE 106 may be capable of communicating using multiple wireless communication standards. For example, the UE 106 may be configured to communicate using a wireless networking (e.g., Wi-Fi) and/or peer-to-peer wireless communication protocol (e.g., Bluetooth, Wi-Fi peer-to-peer, etc.) in addition to at least one cellular communication protocol (e.g., GSM, UMTS (associated with, for example, WCDMA or TD-SCDMA air interfaces), LTE, LTE-A, 5G NR, HSPA, 3GPP2 CDMA2000 (e.g., 1×RTT, 1×EV-DO, HRPD, eHRPD), etc.). The UE 106 may also or alternatively be configured to communicate using one or more global navigational satellite systems (GNSS, e.g., GPS or GLONASS), one or more mobile television broadcasting standards (e.g., ATSC-M/H or DVB-H), and/or any other wireless communication protocol, if desired. Other combinations of wireless communication standards (including more than two wireless communication standards) are also possible.

FIG. 2 illustrates user equipment 106 (e.g., one of the devices 106A through 106N) in communication with a base station 102, according to some embodiments. The UE 106 may be a device with cellular communication capability such as a mobile phone, a hand-held device, a computer or a tablet, or virtually any type of wireless device.

The UE 106 may include a processor that is configured to execute program instructions stored in memory. The UE 106 may perform any of the method embodiments described herein by executing such stored instructions. Alternatively, or in addition, the UE 106 may include a programmable hardware element such as an FPGA (field-programmable gate array) that is configured to perform any of the method embodiments described herein, or any portion of any of the method embodiments described herein.

The UE 106 may include one or more antennas for communicating using one or more wireless communication protocols or technologies. In some embodiments, the UE 106 may be configured to communicate using, for example, CDMA2000 (1×RTT/1×EV-DO/HRPD/eHRPD) or LTE using a single shared radio and/or GSM or LTE using the single shared radio. The shared radio may couple to a single antenna, or may couple to multiple antennas (e.g., for MIMO) for performing wireless communications. In general, a radio may include any combination of a baseband processor, analog RF signal processing circuitry (e.g., including filters, mixers, oscillators, amplifiers, etc.), or digital processing circuitry (e.g., for digital modulation as well as other digital processing). Similarly, the radio may implement one or more receive and transmit chains using the aforementioned hardware. For example, the UE 106 may share one or more parts of a receive and/or transmit chain between multiple wireless communication technologies, such as those discussed above.

In some embodiments, the UE 106 may include separate transmit and/or receive chains (e.g., including separate antennas and other radio components) for each wireless communication protocol with which it is configured to communicate. As a further possibility, the UE 106 may include one or more radios which are shared between multiple wireless communication protocols, and one or more radios which are used exclusively by a single wireless communication protocol. For example, the UE 106 might include a shared radio for communicating using either of LTE or 5G NR (or LTE or 1×RTT or LTE or GSM), and separate radios for communicating using each of Wi-Fi and Bluetooth. Other configurations are also possible.

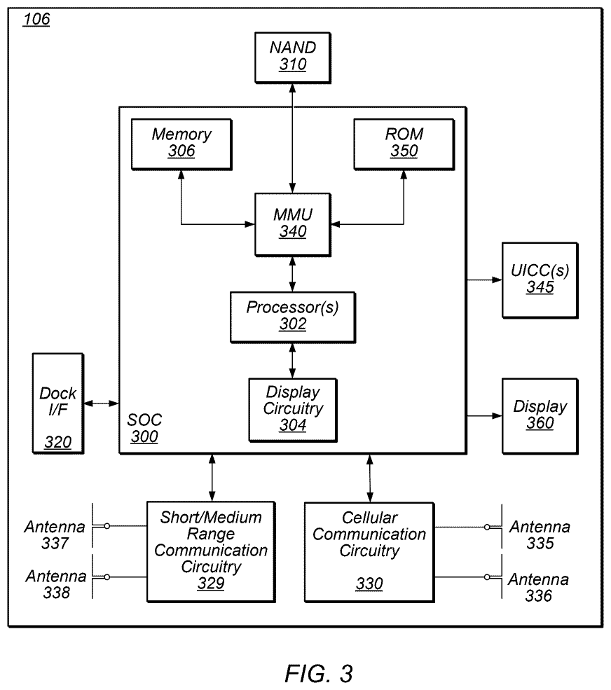

### FIG. 3—Block Diagram of a UE

FIG. 3 illustrates an example simplified block diagram of a communication device 106, according to some embodiments. It is noted that the block diagram of the communication device of FIG. 3 is only one example of a possible communication device. According to embodiments, communication device 106 may be a user equipment (UE) device, a mobile device or mobile station, a wireless device or wireless station, a desktop computer or computing device, a mobile computing device (e.g., a laptop, notebook, or portable computing device), a tablet and/or a combination of devices, among other devices. As shown, the communication device 106 may include a set of components 300 configured to perform core functions. For example, this set of components may be implemented as a system on chip (SOC), which may include portions for various purposes. Alternatively, this set of components 300 may be implemented as separate components or groups of components for the various purposes. The set of components 300 may be coupled (e.g., communicatively; directly or indirectly) to various other circuits of the communication device 106.

For example, the communication device 106 may include various types of memory (e.g., including NAND flash 310), an input/output interface such as connector I/F 320 (e.g., for connecting to a computer system; dock; charging station; input devices, such as a microphone, camera, keyboard; output devices, such as speakers; etc.), the display 360, which may be integrated with or external to the communication device 106, and cellular communication circuitry 330 such as for 5G NR, LTE, GSM, etc., and short to medium range wireless communication circuitry 329 (e.g., Bluetooth™ and WLAN circuitry). In some embodiments, communication device 106 may include wired communication circuitry (not shown), such as a network interface card, e.g., for Ethernet.

The cellular communication circuitry 330 may couple (e.g., communicatively; directly or indirectly) to one or more antennas, such as antennas 335 and 336 as shown. The short to medium range wireless communication circuitry 329 may also couple (e.g., communicatively; directly or indirectly) to one or more antennas, such as antennas 337 and 338 as shown. Alternatively, the short to medium range wireless communication circuitry 329 may couple (e.g., communicatively; directly or indirectly) to the antennas 335 and 336 in addition to, or instead of, coupling (e.g., communicatively; directly or indirectly) to the antennas 337 and 338. The short to medium range wireless communication circuitry 329 and/or cellular communication circuitry 330 may include multiple receive chains and/or multiple transmit chains for receiving and/or transmitting multiple spatial streams, such as in a multiple-input multiple output (MIMO) configuration.

In some embodiments, as further described below, cellular communication circuitry 330 may include dedicated receive chains (including and/or coupled to, e.g., communicatively; directly or indirectly, dedicated processors and/or radios) for multiple RATs (e.g., a first receive chain for LTE and a second receive chain for 5G NR). In addition, in some embodiments, cellular communication circuitry 330 may include a single transmit chain that may be switched between radios dedicated to specific RATs. For example, a first radio may be dedicated to a first RAT, e.g., LTE, and may be in communication with a dedicated receive chain and a transmit chain shared with an additional radio, e.g., a second radio that may be dedicated to a second RAT, e.g., 5G NR, and may be in communication with a dedicated receive chain and the shared transmit chain.

The communication device 106 may also include and/or be configured for use with one or more user interface elements. The user interface elements may include any of various elements, such as display 360 (which may be a touchscreen display), a keyboard (which may be a discrete keyboard or may be implemented as part of a touchscreen display), a mouse, a microphone and/or speakers, one or more cameras, one or more buttons, and/or any of various other elements capable of providing information to a user and/or receiving or interpreting user input.

The communication device 106 may further include one or more smart cards 345 that include SIM (Subscriber Identity Module) functionality, such as one or more UICC(s) (Universal Integrated Circuit Card(s)) cards 345.

As shown, the SOC 300 may include processor(s) 302, which may execute program instructions for the communication device 106 and display circuitry 304, which may perform graphics processing and provide display signals to the display 360. The processor(s) 302 may also be coupled to memory management unit (MMU) 340, which may be configured to receive addresses from the processor(s) 302 and translate those addresses to locations in memory (e.g., memory 306, read only memory (ROM) 350, NAND flash memory 310) and/or to other circuits or devices, such as the display circuitry 304, short range wireless communication circuitry 229, cellular communication circuitry 330, connector I/F 320, and/or display 360. The MMU 340 may be configured to perform memory protection and page table translation or set up. In some embodiments, the MMU 340 may be included as a portion of the processor(s) 302.

As noted above, the communication device 106 may be configured to communicate using wireless and/or wired communication circuitry. The communication device 106 may be configured to transmit a request to attach to a first network node operating according to the first RAT and transmit an indication that the wireless device is capable of maintaining substantially concurrent connections with the first network node and a second network node that operates according to the second RAT. The wireless device may also be configured transmit a request to attach to the second network node. The request may include an indication that the wireless device is capable of maintaining substantially concurrent connections with the first and second network nodes. Further, the wireless device may be configured to receive an indication that dual connectivity with the first and second network nodes has been established.

As described herein, the communication device 106 may include hardware and software components for implementing the above features for time division multiplexing UL data for NSA NR operations. The processor 302 of the communication device 106 may be configured to implement part or all of the features described herein, e.g., by executing program instructions stored on a memory medium (e.g., a non-transitory computer-readable memory medium). Alternatively (or in addition), processor 302 may be configured as a programmable hardware element, such as an FPGA (Field Programmable Gate Array), or as an ASIC (Application Specific Integrated Circuit). Alternatively (or in addition) the processor 302 of the communication device 106, in conjunction with one or more of the other components 300, 304, 306, 310, 320, 329, 330, 340, 345, 350, 360 may be configured to implement part or all of the features described herein.

In addition, as described herein, processor 302 may include one or more processing elements. Thus, processor 302 may include one or more integrated circuits (ICs) that are configured to perform the functions of processor 302. In addition, each integrated circuit may include circuitry (e.g., first circuitry, second circuitry, etc.) configured to perform the functions of processor(s) 302.

Further, as described herein, cellular communication circuitry 330 and short range wireless communication circuitry 329 may each include one or more processing elements. In other words, one or more processing elements may be included in cellular communication circuitry 330 and, similarly, one or more processing elements may be included in short range wireless communication circuitry 329. Thus, cellular communication circuitry 330 may include one or more integrated circuits (ICs) that are configured to perform the functions of cellular communication circuitry 330. In addition, each integrated circuit may include circuitry (e.g., first circuitry, second circuitry, etc.) configured to perform the functions of cellular communication circuitry 230. Similarly, the short range wireless communication circuitry 329 may include one or more ICs that are configured to perform the functions of short range wireless communication circuitry 32. In addition, each integrated circuit may include circuitry (e.g., first circuitry, second circuitry, etc.) configured to perform the functions of short range wireless communication circuitry 329.

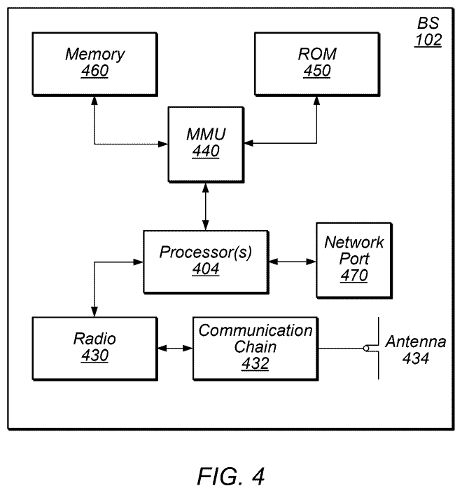

### FIG. 4—Block Diagram of a Base Station

FIG. 4 illustrates an example block diagram of a base station 102, according to some embodiments. It is noted that the base station of FIG. 4 is merely one example of a possible base station. As shown, the base station 102 may include processor(s) 404 which may execute program instructions for the base station 102. The processor(s) 404 may also be coupled to memory management unit (MMU) 440, which may be configured to receive addresses from the processor(s) 404 and translate those addresses to locations in memory (e.g., memory 460 and read only memory (ROM) 450) or to other circuits or devices.

The base station 102 may include at least one network port 470. The network port 470 may be configured to couple to a telephone network and provide a plurality of devices, such as UE devices 106, access to the telephone network as described above in FIGS. 1 and 2.

The network port 470 (or an additional network port) may also or alternatively be configured to couple to a cellular network, e.g., a core network of a cellular service provider. The core network may provide mobility related services and/or other services to a plurality of devices, such as UE devices 106. In some cases, the network port 470 may couple to a telephone network via the core network, and/or the core network may provide a telephone network (e.g., among other UE devices serviced by the cellular service provider).

In some embodiments, base station 102 may be a next generation base station, e.g., a 5G New Radio (5G NR) base station, or “gNB”. In such embodiments, base station 102 may be connected to a legacy evolved packet core (EPC) network and/or to a NR core (NRC) network. In addition, base station 102 may be considered a 5G NR cell and may include one or more transmission and reception points (TRPs). In addition, a UE capable of operating according to 5G NR may be connected to one or more TRPs within one or more gNBs.

The base station 102 may include at least one antenna 434, and possibly multiple antennas. The at least one antenna 434 may be configured to operate as a wireless transceiver and may be further configured to communicate with UE devices 106 via radio 430. The antenna 434 communicates with the radio 430 via communication chain 432. Communication chain 432 may be a receive chain, a transmit chain or both. The radio 430 may be configured to communicate via various wireless communication standards, including, but not limited to, 5G NR, LTE, LTE-A, GSM, UMTS, CDMA2000, Wi-Fi, etc.

The base station 102 may be configured to communicate wirelessly using multiple wireless communication standards. In some instances, the base station 102 may include multiple radios, which may enable the base station 102 to communicate according to multiple wireless communication technologies. For example, as one possibility, the base station 102 may include an LTE radio for performing communication according to LTE as well as a 5G NR radio for performing communication according to 5G NR. In such a case, the base station 102 may be capable of operating as both an LTE base station and a 5G NR base station. As another possibility, the base station 102 may include a multi-mode radio which is capable of performing communications according to any of multiple wireless communication technologies (e.g., 5GNR and Wi-Fi, LTE and Wi-Fi, LTE and UMTS, LTE and CDMA2000, UMTS and GSM, etc.).

As described further subsequently herein, the BS 102 may include hardware and software components for implementing or supporting implementation of features described herein. The processor 404 of the base station 102 may be configured to implement or support implementation of part or all of the methods described herein, e.g., by executing program instructions stored on a memory medium (e.g., a non-transitory computer-readable memory medium). Alternatively, the processor 404 may be configured as a programmable hardware element, such as an FPGA (Field Programmable Gate Array), or as an ASIC (Application Specific Integrated Circuit), or a combination thereof. Alternatively (or in addition) the processor 404 of the BS 102, in conjunction with one or more of the other components 430, 432, 434, 440, 450, 460, 470 may be configured to implement or support implementation of part or all of the features described herein.

In addition, as described herein, processor(s) 404 may be comprised of one or more processing elements. In other words, one or more processing elements may be included in processor(s) 404. Thus, processor(s) 404 may include one or more integrated circuits (ICs) that are configured to perform the functions of processor(s) 404. In addition, each integrated circuit may include circuitry (e.g., first circuitry, second circuitry, etc.) configured to perform the functions of processor(s) 404.

Further, as described herein, radio 430 may be comprised of one or more processing elements. In other words, one or more processing elements may be included in radio 430. Thus, radio 430 may include one or more integrated circuits (ICs) that are configured to perform the functions of radio 430. In addition, each integrated circuit may include circuitry (e.g., first circuitry, second circuitry, etc.) configured to perform the functions of radio 430.

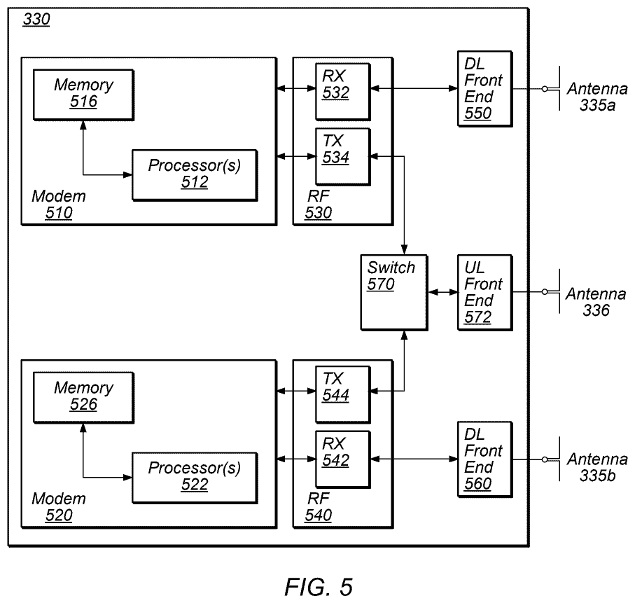

### FIG. 5: Block Diagram of Cellular Communication Circuitry

FIG. 5 illustrates an example simplified block diagram of cellular communication circuitry, according to some embodiments. It is noted that the block diagram of the cellular communication circuitry of FIG. 5 is only one example of a possible cellular communication circuit. According to embodiments, cellular communication circuitry 330 may be include in a communication device, such as communication device 106 described above. As noted above, communication device 106 may be a user equipment (UE) device, a mobile device or mobile station, a wireless device or wireless station, a desktop computer or computing device, a mobile computing device (e.g., a laptop, notebook, or portable computing device), a tablet and/or a combination of devices, among other devices.

The cellular communication circuitry 330 may couple (e.g., communicatively; directly or indirectly) to one or more antennas, such as antennas 335a-b and 336 as shown (in FIG. 3). In some embodiments, cellular communication circuitry 330 may include dedicated receive chains (including and/or coupled to, e.g., communicatively; directly or indirectly, dedicated processors and/or radios) for multiple RATs (e.g., a first receive chain for LTE and a second receive chain for 5GNR). For example, as shown in FIG. 5, cellular communication circuitry 330 may include a modem 510 and a modem 520. Modem 510 may be configured for communications according to a first RAT, e.g., such as LTE or LTE-A, and modem 520 may be configured for communications according to a second RAT, e.g., such as 5G NR.

As shown, modem 510 may include one or more processors 512 and a memory 516 in communication with processors 512. Modem 510 may be in communication with a radio frequency (RF) front end 530. RF front end 530 may include circuitry for transmitting and receiving radio signals. For example, RF front end 530 may include receive circuitry (RX) 532 and transmit circuitry (TX) 534. In some embodiments, receive circuitry 532 may be in communication with downlink (DL) front end 550, which may include circuitry for receiving radio signals via antenna 335a.

Similarly, modem 520 may include one or more processors 522 and a memory 526 in communication with processors 522. Modem 520 may be in communication with an RF front end 540. RF front end 540 may include circuitry for transmitting and receiving radio signals. For example, RF front end 540 may include receive circuitry 542 and transmit circuitry 544. In some embodiments, receive circuitry 542 may be in communication with DL front end 560, which may include circuitry for receiving radio signals via antenna 335b.

In some embodiments, a switch 570 may couple transmit circuitry 534 to uplink (UL) front end 572. In addition, switch 570 may couple transmit circuitry 544 to UL front end 572. UL front end 572 may include circuitry for transmitting radio signals via antenna 336. Thus, when cellular communication circuitry 330 receives instructions to transmit according to the first RAT (e.g., as supported via modem 510), switch 570 may be switched to a first state that allows modem 510 to transmit signals according to the first RAT (e.g., via a transmit chain that includes transmit circuitry 534 and UL front end 572). Similarly, when cellular communication circuitry 330 receives instructions to transmit according to the second RAT (e.g., as supported via modem 520), switch 570 may be switched to a second state that allows modem 520 to transmit signals according to the second RAT (e.g., via a transmit chain that includes transmit circuitry 544 and UL front end 572).

In some embodiments, the cellular communication circuitry 330 may be configured to establish a first wireless link with a first cell according to a first radio access technology (RAT), wherein the first cell operates in a first system bandwidth and establish a second wireless link with a second cell according to a second radio access technology (RAT), wherein the second cell operates in a second system bandwidth. Further, the cellular communication circuitry 330 may be configured to determine whether the cellular communication circuitry 330 has uplink activity scheduled according to both the first RAT and the second RAT and perform uplink activity for both the first RAT and the second RAT by time division multiplexing (TDM) uplink data for the first RAT and uplink data for the second RAT if uplink activity is scheduled according to both the first RAT and the second RAT. In some embodiments, to perform uplink activity for both the first RAT and the second RAT by time division multiplexing (TDM) uplink data for the first RAT and uplink data for the second RAT if uplink activity is scheduled according to both the first RAT and the second RAT, the cellular communication circuitry 330 may be configured to receive an allocation of a first UL subframe for transmissions according to the first RAT and an allocation of a second UL subframe for transmissions according to the second RAT. In some embodiments, the TDM of the uplink data may be performed at a physical layer of the cellular communication circuitry 330. In some embodiments, the cellular communication circuitry 330 may be further configured to receive an allocation of a portion of each UL subframe for control signaling according to one of the first or second RATs.

As described herein, the modem 510 may include hardware and software components for implementing the above features or for time division multiplexing UL data for NSA NR operations, as well as the various other techniques described herein. The processors 512 may be configured to implement part or all of the features described herein, e.g., by executing program instructions stored on a memory medium (e.g., a non-transitory computer-readable memory medium). Alternatively (or in addition), processor 512 may be configured as a programmable hardware element, such as an FPGA (Field Programmable Gate Array), or as an ASIC (Application Specific Integrated Circuit). Alternatively (or in addition) the processor 512, in conjunction with one or more of the other components 530, 532, 534, 550, 570, 572, 335 and 336 may be configured to implement part or all of the features described herein.

In addition, as described herein, processors 512 may include one or more processing elements. Thus, processors 512 may include one or more integrated circuits (ICs) that are configured to perform the functions of processors 512. In addition, each integrated circuit may include circuitry (e.g., first circuitry, second circuitry, etc.) configured to perform the functions of processors 512.

As described herein, the modem 520 may include hardware and software components for implementing the above features for time division multiplexing UL data for NSA NR operations, as well as the various other techniques described herein. The processors 522 may be configured to implement part or all of the features described herein, e.g., by executing program instructions stored on a memory medium (e.g., a non-transitory computer-readable memory medium). Alternatively (or in addition), processor 522 may be configured as a programmable hardware element, such as an FPGA (Field Programmable Gate Array), or as an ASIC (Application Specific Integrated Circuit). Alternatively (or in addition) the processor 522, in conjunction with one or more of the other components 540, 542, 544, 550, 570, 572, 335 and 336 may be configured to implement part or all of the features described herein.

In addition, as described herein, processors 522 may include one or more processing elements. Thus, processors 522 may include one or more integrated circuits (ICs) that are configured to perform the functions of processors 522. In addition, each integrated circuit may include circuitry (e.g., first circuitry, second circuitry, etc.) configured to perform the functions of processors 522.

5G NR Non-Standalone (NSA) Operation with LTE

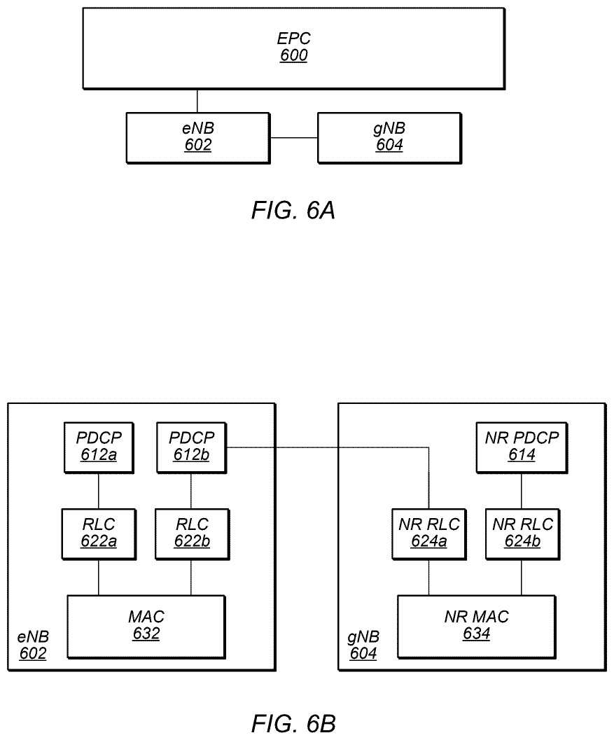

In some implementations, fifth generation (5G) wireless communication will initially be deployed concurrently with current wireless communication standards (e.g., LTE). For example, dual connectivity between LTE and 5G new radio (5G NR or NR) has been specified as part of the initial deployment of NR. Thus, as illustrated in FIGS. 6A-B, evolved packet core (EPC) network 600 may continue to communicate with current LTE base stations (e.g., eNB 602). In addition, eNB 602 may be in communication with a 5G NR base station (e.g., gNB 604) and may pass data between the EPC network 600 and gNB 604. Thus, EPC network 600 may be used (or reused) and gNB 604 may serve as extra capacity for UEs, e.g., for providing increased downlink throughput to UEs. In other words, LTE may be used for control plane signaling and NR may be used for user plane signaling. Thus, LTE may be used to establish connections to the network and NR may be used for data services.

FIG. 6B illustrates a proposed protocol stack for eNB 602 and gNB 604. As shown, eNB 602 may include a medium access control (MAC) layer 632 that interfaces with radio link control (RLC) layers 622a-b. RLC layer 622a may also interface with packet data convergence protocol (PDCP) layer 612a and RLC layer 622b may interface with PDCP layer 612b. Similar to dual connectivity as specified in LTE-Advanced Release 12, PDCP layer 612a may interface via a master cell group (MCG) bearer to EPC network 600 whereas PDCP layer 612b may interface via a split bearer with EPC network 600.

Additionally, as shown, gNB 604 may include a MAC layer 634 that interfaces with RLC layers 624a-b. RLC layer 624a may interface with PDCP layer 622b of eNB 602 via an X₂ interface for information exchange and/or coordination (e.g., scheduling of a UE) between eNB 602 and gNB 604. In addition, RLC layer 624b may interface with PDCP layer 614. Similar to dual connectivity as specified in LTE-Advanced Release 12, PDCP layer 614 may interface with EPC network 600 via a secondary cell group (SCG) bearer. Thus, eNB 602 may be considered a master node (MeNB) while gNB 604 may be considered a secondary node (SgNB). In some scenarios, a UE may be required to maintain a connection to both an MeNB and a SgNB. In such scenarios, the MeNB may be used to maintain a radio resource control (RRC) connection to an EPC while the SgNB may be used for capacity (e.g., additional downlink and/or uplink throughput).

### Reference Signals

A wireless device, such as a user equipment (UE), may be configured to perform a variety of tasks that include the use of reference signals (RS) provided by one or more cellular base stations. For example, initial access and beam measurement by a wireless device may be performed based at least in part on synchronization signal blocks (SSBs) provided by one or more cells provided by one or more cellular base stations within communicative range of the wireless device. Another type of reference signal commonly provided in a cellular communication system may include channel state information (CSI) RS. Various types of CSI-RS may be provided for tracking (e.g., for time and frequency offset tracking), beam management (e.g., with repetition configured, to assist with determining one or more beams to use for uplink and/or downlink communication), and/or channel measurement (e.g., CSI-RS configured in a resource set for measuring the quality of the downlink channel and reporting information related to this quality measurement to the base station), among various possibilities. For example, in the case of CSI-RS for CSI acquisition, the UE may periodically perform channel measurements and send channel state information (CSI) to a BS. The base station can then receive and use this channel state information to determine an adjustment of various parameters during communication with the wireless device. In particular, the BS may use the received channel state information to adjust the coding of its downlink transmissions to improve downlink channel quality.

In many cellular communication systems, the base station may transmit some or all such reference signals (or pilot signals), such as SSB and/or CSI-RS, on a periodic, aperiodic, or semi-persistent basis. In some instances, aperiodic reference signals (e.g., for aperiodic CSI reporting) such as aperiodic channel state information reference signals (AP-CSI-RS) may also or alternatively be provided. In some scenarios, the base station may transmit some or all such reference signals on a semi-persistent basis. According to some scenarios, semi-persistent transmissions may be regarded as a combination of aperiodic and periodic transmissions. For example, an initial transmission of reference signals may be based on an aperiodic occurrence or triggering event which may be followed by a periodic pattern of CSI-RS transmissions and/or CSI reporting.

As a detailed example, in the 3GPP NR cellular communication standard, the channel state information fed back from the UE based on CSI-RS for CSI acquisition may include one or more of a channel quality indicator (CQI), a precoding matrix indicator (PMI), a rank indicator (RI), a CSI-RS Resource Indicator (CRI), a SSBRI (SS/PBCH Resource Block Indicator, and a Layer Indicator (LI), at least according to some embodiments.

The channel quality information may be provided to the base station for link adaptation, e.g., for providing guidance as to which modulation & coding scheme (MCS) the base station should use when it transmits data. For example, when the downlink channel communication quality between the base station and the UE is determined to be high, the UE may feed back a high CQI value, which may cause the base station to transmit data using a relatively high modulation order and/or a low channel coding rate. As another example, when the downlink channel communication quality between the base station and the UE is determined to be low, the UE may feed back a low CQI value, which may cause the base station to transmit data using a relatively low modulation order and/or a high channel coding rate.

Precoding matrix Indicator (PMI) feedback may include preferred precoding matrix information, and may be provided to a base station in order to indicate which MIMO precoding scheme the base station should use. In other words, the UE may measure the quality of a downlink MIMO channel between the base station and the UE, based on a pilot signal received on the channel, and may recommend, through PMI feedback, which MIMO precoding is desired to be applied by the base station. In some cellular systems, the PMI configuration is expressed in matrix form, which provides for linear MIMO precoding. The base station and the UE may share a codebook composed of multiple precoding matrixes, where each MIMO precoding matrix in the codebook may have a unique index. Accordingly, as part of the channel state information fed back by the UE, the PMI may include an index (or possibly multiple indices) corresponding to the most preferred MIMO precoding matrix (or matrixes) in the codebook. This may enable the UE to minimize the amount of feedback information. Thus, the PMI may indicate which precoding matrix from a codebook should be used for transmissions to the UE, at least according to some embodiments.

The rank indicator information (RI feedback) may indicate a number of transmission layers that the UE determines can be supported by the channel, e.g., when the base station and the UE have multiple antennas, which may enable multi-layer transmission through spatial multiplexing. The RI and the PMI may collectively allow the base station to know which precoding needs to be applied to which layer, e.g., depending on the number of transmission layers.

In some cellular systems, a PMI codebook is defined depending on the number of transmission layers. In other words, for R-layer transmission, N number of Nₜ×R matrixes may be defined (e.g., where R represents the number of layers, Nₜ represents the number of transmitter antenna ports, and N represents the size of the codebook). In such a scenario, the number of transmission layers (R) may conform to a rank value of the precoding matrix (Nₜ×R matrix), and hence in this context R may be referred to as the “rank indicator (RI)”.

Thus, the channel state information may include an allocated rank (e.g., a rank indicator or RI). For example, a MIMO-capable UE communicating with a BS may include four receiver chains, e.g., may include four antennas. The BS may also include four or more antennas to enable MIMO communication (e.g., 4×4 MIMO). Thus, the UE may be capable of receiving up to four (or more) signals (e.g., layers) from the BS concurrently. Layer to antenna mapping may be applied, e.g., each layer may be mapped to any number of antenna ports (e.g., antennas). Each antenna port may send and/or receive information associated with one or more layers. The rank may include multiple bits and may indicate the number of signals that the BS may send to the UE in an upcoming time period (e.g., during an upcoming transmission time interval or TTI). For example, an indication of rank 4 may indicate that the BS will send 4 signals to the UE. As one possibility, the RI may be two bits in length (e.g., since two bits are sufficient to distinguish 4 different rank values). Note that other numbers and/or configurations of antennas (e.g., at either or both of the UE or the BS) and/or other numbers of data layers are also possible, according to various embodiments.

### Enhanced Channel State Information Measurement and Reporting at High Movement Speeds

As wireless device usage grows generally, wireless devices are being used in an increasingly wide range of contexts. One such increasingly wide usage range may include the movement speed of a wireless device. Users may at times utilize their wireless devices when stationary, at pedestrian movement speeds, in motor vehicles, and while in even higher speed forms of transport such as high-speed trains, among various possibilities. The movement speed of a wireless device may have a variety of possible effects on the operation of the wireless device. For example, a wireless device moving at a high speed may move from one cell to another more frequently than a wireless device moving at a lower speed, and each such transition between cells may progress according to a more abbreviated timeline. Provided a wireless device can determine at what speed it is currently moving with sufficient accuracy, it may accordingly be possible to modify behaviors of the wireless device in accordance with the movement speed of the wireless device, to potentially improve user experience, reduce power consumption, and/or otherwise provide improved operating characteristics.

High Speed Trains (HSTs) have become an important mode of transportation in many parts of the world. Moreover, travelers frequently utilize wireless devices (e.g., cell phones) during these high-speed transits and therefore this is a scenario of particular interest to user equipment (UE) and network operators. As one scenario, when a HST (and therefore the UE) is in transit, it may travel between two transmission and reception points (TRPs). Accordingly, the UE may observe very high positive Doppler shifts from one TRP and very high negative Doppler shift from the other TRP. As a result, the composite channel may vary quickly (e.g., on the order of 2 kHz or more). This variation of the composite channel may potentially reduce the channel capability and/or make it challenging for UE to perform accurate channel estimation. As one potential solution the UE may be configured to estimate Doppler shifts (from corresponding TRPs) to assist the UE and/or base station (BS) (e.g., the network) in channel estimation procedures such as CSI measurements and reporting. Additionally or alternatively, the network may be configured to pre-compensate for the Doppler shift through specific CMR and/or IMR configurations further corresponding to preferred or more efficient CSI-RS burst patterns and timing. Accordingly, the NW may need to know the Doppler shift and/or UE-preferred CMR/IMR configurations before it is able to provide said enhanced CSI measurement and reporting configurations.

While various and previously released 3GPP standards have supported CSI reporting by exploiting channel correlations such as channel spatial domain properties (e.g., Type I and Type II CSI codebook usage) and channel frequency domain properties (e.g., enhanced Type II CSI codebook usage), there remains a need for channel downlink (DL) and uplink (UL) correlation to be further exploited or utilized for reciprocity based multiple input multiple output (MIMO) operation. Additionally, in regard to UL operation, NR may support non-codebook based physical uplink shared channel (PUSCH) operations. Moreover, in regard to DL operation, NR may support CSI-resource indicator—rank indicator—channel quality indicator (CRI-RI-CQI) reporting and Type II port selection codebook usage. These DL and UL supported operations may be realized or improved through enhanced CSI measurement and reporting procedures.

Additionally, there may be further benefits involved with exploiting or utilizing the channel time domain correlation for CSI reporting. For example, because the wireless channel is typically time varying and the channel has coherence time dependencies due to UE movement speed or the rate at which the wireless environment changes, more efficient CSI measurement and reporting may be possible through utilization of enhanced CMR and/or IMR configurations. Accordingly, channel time domain correlation may be able to be exploited to reduce NW resource allocation and CSI report overhead (thereby reducing UE power consumption) in addition to providing more accurate adaptation to the varying channel. In other words, the UE and NW may be able to coordinate, based on known or determined conditions, so as to perform more efficient CSI measurement and reporting procedures while the UE is moving at high speed.

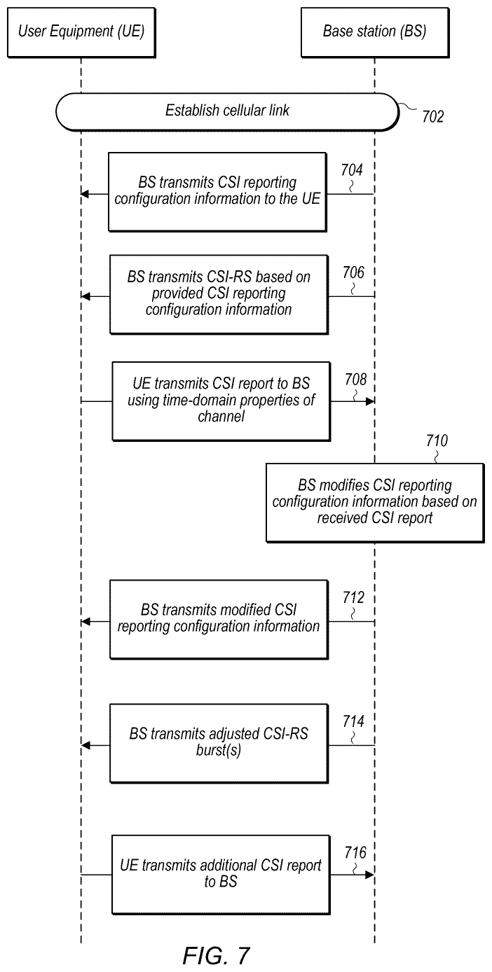

### FIG. 7—Method for Enhanced CSI Measurement and Reporting at High Movement Speeds

As wireless device capabilities increase, it may be useful to provide techniques that can make use of those increased wireless device capabilities, for example to improve the reliability of wireless communications, to reduce the latency of wireless communications, to increase the amount of data that can be communicated, and/or for any of various other possible reasons.

One wireless device capability that may be beneficial to make use of when performing wireless communications may include the ability to perform enhanced CSI measurements and/or reporting to increase the amount of data that can be transmitted and/or to improve the reliability of wireless communications by utilizing coordinated and preferential measurement patterns to assess the channel.

Thus, it may be beneficial to specify techniques for performing enhanced CSI measurement and/or reporting while moving at high movement speeds, at least in some instances. To illustrate such possible techniques, FIG. 7 is a signal flow diagram illustrating methods for a wireless communication system including performing of enhanced CSI measurement and reporting techniques at high movement speeds, at least according to some embodiments.

Aspects of the method of FIG. 7 may be implemented by a base station, such as the BS 102, in communication with one or more user equipments (e.g., UE(s) 106) as illustrated in and described with respect to the Figures, or more generally in conjunction with any of the computer systems or devices shown in the Figures, among other circuitry, systems, devices, elements, or components shown in the Figures, among other devices, as desired. For example, one or more processors (or processing elements) of the BS (e.g., processor(s) 404, baseband processor(s), processor(s) associated with communication circuitry, etc., among various possibilities) may cause the BS to perform some or all of the illustrated method elements. Note that while at least some elements of the method are described in a manner relating to the use of communication techniques and/or features associated with 3GPP specification documents, such description is not intended to be limiting to the disclosure, and aspects of the method may be used in any suitable wireless communication system, as desired. In various embodiments, some of the elements of the methods shown may be performed concurrently, in a different order than shown, may be substituted for by other method elements, or may be omitted. Additional method elements may also be performed as desired. As shown, the method may operate as follows.

In 702, the network (e.g., a BS) may establish a cellular link with a wireless device (e.g., a UE). In some instances, the cellular link may be used to provide service to wireless devices travelling in high-speed trains. According to some embodiments, the cellular link may operate according to 5G NR. For example, the wireless device may establish a session with an AMF entity of the cellular network by way of one or more gNBs that provide radio access to the cellular network. As another possibility, the cellular link may operate according to LTE. For example, the wireless device may establish a session with a mobility management entity of the cellular network by way of an eNB that provides radio access to the cellular network. Other types of cellular links are also possible, and the cellular network may also or alternatively operate according to another cellular communication technology (e.g., UMTS, CDMA2000, GSM, etc.), according to various embodiments.

Establishing the wireless link may include establishing a RRC connection with a serving cellular base station, at least according to some embodiments. Establishing the first RRC connection may include configuring various parameters for communication between the wireless device and the cellular base station, establishing context information for the wireless device, and/or any of various other possible features, e.g., relating to establishing an air interface for the wireless device to perform cellular communication with a cellular network associated with the cellular base station. After establishing the RRC connection, the wireless device may operate in a RRC connected state. In some instances, the RRC connection may also be released (e.g., after a period of inactivity with respect to data communication), in which case the wireless device may operate in a RRC idle state or a RRC inactive state. In some instances, the wireless device may perform handover (e.g., while in RRC connected mode) or cell re-selection (e.g., while in RRC idle or RRC inactive mode) to anew serving cell, e.g., due to wireless device mobility, changing wireless medium conditions, and/or for any of various other possible reasons.

At least in some instances, establishing the wireless link(s) may include the wireless device providing capability information for the wireless device. Such capability information may include information relating to any of a variety of types of wireless device capabilities. For example, the UE may indicate CMR and/or IMR configuration capabilities or preferences of the UE. More specifically, the UE may indicate preferential CMR and/or IMR configurations corresponding to channel state information-reference signal (CSI-RS) burst patterns and/or timing thereof, according to some embodiments.

In 704, the BS may transmit signaling to the UE to configure the UE with at least one of one or more channel measurement resource (CMR) or one or more interference measurement resource (IMR) configurations, according to some embodiments. For example, the BS may provide the UE with configuration information relating to CMRs and IMRs for performing CSI related measurements or reporting. In some instances, the BS may use RRC signaling to transmit the configuration information.

According to some embodiments, the configurations (e.g., configuration information) may further comprise information relating to time-domain properties of CSI-RS signaling. For example, the CSI configuration information may specify the number of CSI-RS per burst and/or the time domain distance between adjacent CSI-RS in a burst, among other possibilities. Accordingly, this information may be useful for the UE in subsequent channel measurement and reporting operations.

In 706, the BS may transmit CSI-RS based on the provided CMR/IMR configurations, according to some embodiments. In other words, the BS may transmit a burst of one or more CSI-RS according to the configuration information provided to the UE in 704. For example, if the configuration information of 704 specified a burst of four CSI-RS with equal spacing (e.g., ˜5 ms between each adjacent CSI-RS, as one example), the UE may expect to receive the four CSI-RS with the corresponding spacings in time.

According to some embodiments, each burst of the CSI-RS for CMR (e.g., non-zero power CSI-RS (NZP-CSI-RS)) may contain multiple NZP-CSI-RS resources and the multiple NZP-CSI-RS resources in the same burst may be characterized by time and frequency domain (among other) properties. For example, the multiple NZP-CSI-RS resources may be equally spaced in the time domain, have the same frequency domain allocation, have the same number of ports (e.g., antenna ports), have the same QCL assumption (e.g., they are quasi-colocated), and/or share the same time domain pattern (e.g., periodic or semi-persistent or aperiodic), according to some embodiments. Moreover, for periodic or semi-persistent CSI-RS patterns, the multiple NZP-CSI-RS resources may have the same periodicity.

In some embodiments, enhanced CSI reporting through exploitation of channel time domain properties in terms of CMR configurations may involve one or multiple CSI-RS bursts being configured for the same CSI report. In other words, the BS may be able to transmit one or multiple CSI-RS bursts for the UE to utilize in its CSI measurements and/or reporting. For example, when multiple CSI-RS bursts are transmitted, different CSI-RS bursts may be interlaced or staggered in the time domain such that they are non-overlapping. In other words, adjacent CSI-RS may be associated with two different bursts or burst patterns, according to some embodiments. For example, the two different CSI-RS bursts may be interlaced through the two bursts being offset in time. Additionally or alternatively, the CSI-RS corresponding to different CSI-RS bursts may be characterized by time, frequency, and other properties. For example, the different CSI-RS bursts may correspond to a same or different number of CSI-RS per burst, a same or different time domain distance, a same or different frequency domain allocation, a same or different number of may be the same, a same or different QCL assumption, and/or the time domain pattern (i.e., periodic or semi-persistent or aperiodic) may be the same or different, according to some embodiments.

According to some embodiments, the UE may, having received the CSI-RS from the base station in 706, perform measurements of the CSI-RS in order to assess or determine the quality of the of the channel. For example, the UE may use the CSI-RS configured in a resource set for measuring the quality of the downlink channel. Additionally, the UE may generate reporting information related to this quality measurement (e.g., a CSI report) and provide this information to the base station, among various possibilities.

In 708, the BS may receive a CSI report from the UE. For example, having performed measurements according to the CSI-RS transmitted by the BS in 706 and further corresponding to the configuration information provided in 704, the UE may transmit a report to the BS detailing channel metrics or information. In other words, the cellular network (e.g., a cellular base station configured to provide one or more TRPs in the cellular network) may receive signaling from the wireless device (e.g., the UE) including measurement information corresponding to channel state information (CSI) (e.g., the CSI report). For example, having measured one or more channel state information-reference signal (CSI-RS) burst patterns transmitted from the base station, the UE may transmit a CSI report. In some embodiments, the CSI report may include the cellular device's (e.g., the UE's) CSI reporting preferences corresponding to CMR and/or IMR configurations.

According to some embodiments, the CSI report may use time-domain properties of the channel corresponding to the one or more CSI-RS received by the UE in 706. For example, the UE may generate a CSI report based on the time-domain properties of the channel and further corresponding to the CSI reporting configuration information of 704 and the burst of one or more CSI-RS of 706. More specifically, the time-domain properties usable by the UE in generating a CSI report may include information related to at least one of the number of CSI-RS per burst or the time-domain spacing of the CSI-RS as well as their relation to Doppler shift and/or spread information. Accordingly, it may be possible for the UE and/or BS to perform CSI procedures such as CSI compression and/or CSI prediction through use of the channel time domain properties without having to directly report the channel time domain properties. In other words, the BS and/or UE may be able to predict channel quality measurements or information based on previously reported or known channel conditions (e.g., CSI) and proactively provide or use enhanced CSI reporting configuration information to enable more efficient CSI operations. For example, by utilizing preferred or predicted CSI reporting configurations, the BS may be able to reduce network resource allocations to provide more accurate and flexible adaptations to the time-varying channel conditions. Similarly, the UE may benefit from reduced CSI reporting overhead and power consumption realized through CSI measurement and reporting operations of preferred or predicted CSI reporting configurations.

Additionally or alternatively, CSI reports may include Doppler shift and/or spread measurement information corresponding to any or all TRPs of the network that the wireless device may be in communication or interacting with. For example, due to the UE travelling at high speeds, the UE may have measured higher or positive Doppler shift measurements from one TRP and lower or negative Doppler shift measurements from another TRP. Accordingly, in order to facilitate a better connection with the network, the UE may elect to transmit this information to the network. In some embodiments, the UE may provide additional indications of CMR and/or IMR configuration capabilities or preferences of the UE. For example, the UE may indicate preferential CMR and/or IMR configurations corresponding to channel state information-reference signal (CSI-RS) burst patterns and/or timing thereof. For example, in the scenario of CSI-RS for CSI acquisition, the UE may periodically perform channel measurements and send CSI to a BS. The base station can then receive and use this channel state information to determine an adjustment of various parameters during communication with the wireless device. In particular, the BS may use the received channel state information to adjust the coding of its downlink transmissions to improve downlink channel quality, according to some embodiments.

More specifically, in the example of the received CSI report including Doppler shift or Doppler spread measurement information, when the UE reports high Doppler shift or Doppler spread measurement result, the network may determine that it should configure the UE with different CMR and/or IMR configurations to compensate for the measured high Doppler shift or Doppler spread. Additionally or alternatively, if the UE reports low to medium Doppler shift or Doppler spread measurement information, the network may provide the UE with a CMR and/or IMR configuration with minor adjustments to the CSI-RS burst pattern and/or timing gap between bursts or their respective CSI-RS signals.

In some embodiments, the CSI report may be configured in a CSI-ReportConfig parameter (e.g., provided from the network to the UE in 702 and/or 704), according to some embodiments. Furthermore, in CSI-ReportConfig, the measurement reference signals (RS) may be configured in additional parameters or fields such as carrier which indicates which serving cell contains the measurement reference signals. Additionally, the resourcesForChannelMeasurement parameter/field of the CSI-ReportConfig may be used to indicate which CSI-ResourceConfig contains the CMR. Similarly, the csi-IM-ResourcesForInterference parameter/field may be utilized to indicate which CSI-ResourceConfig contains the ZP-IMR (Zero Power-Interference Measurement Resource). Accordingly, this ZP-IMR may be utilized by the UE in performing interference measurements. Moreover, according to some embodiments, ZP-IMRs may correspond to a scenario in which the UE measures for interference with the base station acting in a passive sense. In other words, the UE may measure the interference based on total received signal on a ZP-IMR, while the serving base station may not be expected to transmit on the ZP-IMR.

Additionally or alternatively, the nzp-CSI-RS-ResourcesForInterference parameter/field (e.g., provided from the network to the UE in 702 and/or 704) may be used to indicate which CSI-ResourceConfig contains the NZP-IMR (Non-Zero-Power Interference Measurement Resource). Accordingly, NZP-IMRs may also be utilized by the UE in performing interference measurements. For example, according to some embodiments, NZP-IMRs may correspond to a scenario in which the UE measures for interference with the base station acting in an active sense. In other words, the UE may measure to the appropriate channel(s) through utilization of interference signaling provided by the base station on an NZP-IMR and make a determination of interference based on comparison of the channel(s).

According to some embodiments, the CSI measurement resource in NR may be configured in the CSI-ResourceConfig parameter/field. Additionally or alternatively, the time domain pattern may be configured in the resourceType parameter/field (e.g., provided from the network to the UE in 702 and/or 704) which may correspond to three different time domain patterns (aperiodic, semi-persistent, periodic). More specifically, each CSI-ResourceConfig may be configured with one or multiple NZP-CSI-RS-ResourceSet parameters and each ZP-CSI-RS-ResourceSet may be configured with one or multiple NZP-CSI-RS-Resource. According to some embodiments, each CSI-ReportConfig parameter may only be associated with one NZP-CSI-RS-ResourceSet for CMR.

In 710, the BS may modify the configuration information of the CMR(s) and/or IMR(s) based on the received CSI report, according to some embodiments. For example, if the UE reported a preferred CMR and/or IMR configuration, the BS may be able to modify the configuration information to support or accommodate the UE's preferences so as to allow for more efficient CSI measurements and reporting. More specifically, the BS may modify or adjust the CMR and/or IMR configuration information (e.g., the number of CSI-RS per burst and the time domain distance between adjacent CSI-RS, for example) based on the received CSI report of 708.

In 712, the BS may transmit signaling to the UE to configure the UE with the modified CMR/IMR configurations based on the received CSI report, according to some embodiments. For example, having modified the appropriate configurations in 710 further in response to the information received in the CSI report of 708, the BS may transmit one or more new or additional CMR/IMR configuration(s) to the UE to be used for subsequent CSI measurements. Accordingly, the UE may be better suited to perform said subsequent CSI measurement and reporting by using the newly adjusted or modified CMR/IMR configuration(s), according to some embodiments.

In 714, the BS may transmit additional CSI-RS to the UE based on the updated CMR/IMR configurations sent to the UE in 712, according to some embodiments. For example, having provided the UE with adjusted or modified CSI configuration information in 712, the BS may proceed to transmit reference signals which correspond to the adjustments of the modified configuration information. In other words, the BS may transmit one or more adjusted or modified CSI-RS using the updated number of CSI-RS per burst and/or time domain spacing of the modified CSI configuration information, according to some embodiments. Accordingly, the UE may be able to perform more efficient CSI measurements based on the adjusted or modified number of CSI-RS per burst and/or modified time domain spacing of the adjacent CSI-RS corresponding to the modified CSI configuration information (e.g., CMR/IMR configuration(s)).

In 716, the UE may transmit an additional CSI report to the BS, according to some embodiments. For example, having performed additional channel measurements on the adjusted/modified CSI-RS transmitted to the UE in 714, the UE may further generate a new CSI report and transmit this to the BS. Accordingly, in some embodiments, it may be beneficial for the UE to request further improvements or modifications to the CSI-RS signaling patterns and therefore may repeat at least some of 702-716 as necessary, according to some embodiments.

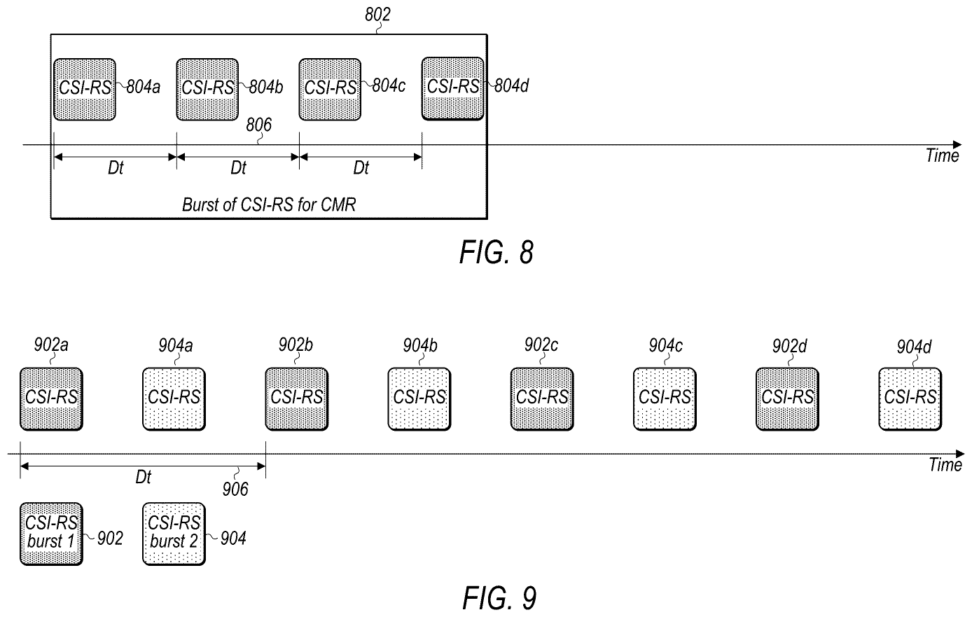

### FIGS. 8-9—Example CSI-RS Burst Patterns for CMR

FIGS. 8-9 illustrate example channel state information-reference signal (CSI-RS) burst patterns and timing corresponding to channel measurement resource (CMR) configurations, according to some embodiments. More specifically, FIGS. 8 and 9 describe various examples of how CSI reporting enhancements may involve exploiting channel time domain properties in terms of CMR configurations in which bursts of NZP-CSI-RS can be defined for channel measurement.

As illustrated by FIG. 8, a burst of CSI-RS for CMR 802 may include multiple CSI-RS such as 804a, 804b, 804c, and 804d, according to some embodiments. Furthermore, each CSI-RS in the burst may be separated equally in time such as Dt 806. However, it may be possible to have more or less CSI-RS in a burst 802 or different time domain spacing Dt 806 depending on the CMR/IMR configuration provided by the base station. Moreover, it may be possible to adjust or modify the number of CSI-RS per burst or time domain spacing 806 of the burst 802 as indicated in the CMR/IMR configuration, according to some embodiments.

In some embodiments, each burst of NZP-CSI-RS may contain multiple NZP-CSI-RS resources (e.g., CSI-RS 804a-d, for example) and the multiple NZP-CSI-RS resources in the same burst may be subject to one or more restrictions. For example, the multiple NZP-CSI-RS resources may be equally spaced in the time domain, have the same frequency domain allocation, have the same number of ports (e.g., antenna ports), have the same QCL assumption (e.g., they are quasi-colocated), and/or share the same time domain pattern (i.e., periodic or semi-persistent or aperiodic), according to some embodiments. Moreover, for periodic or semi-persistent CSI-RS, the multiple NZP-CSI-RS resources may have the same periodicity.

According to some embodiments, enhanced CSI reporting through exploitation of channel time domain properties in terms of CMR configurations may involve multiple CSI-RS bursts being configured for the same CSI report. For example, as illustrated in FIG. 9, different CSI-RS bursts 902 and 904 may be interlaced or staggered in the time domain such that they are non-overlapping. Accordingly, the CSI-RS of CSI-RS burst 1 902 may correspond to CSI-RS 902a, 902b, 902c, and 902d which are interlaced with CSI-RS 904a, 904b, 904c, and 904d of CSI-RS burst 2 904. Moreover, Dt 906 may correspond the time domain spacing between CSI-RS of CSI-RS burst 1 902. Additionally or alternatively, Dt 906 may also correspond the time domain spacing between CSI-RS of CSI-RS burst 2 904, according to some embodiments. Moreover, it may be possible to adjust or modify the number of CSI-RS or time domain spacing 906 of the bursts 902 and/or 904 as indicated in their respective CMR/IMR configurations, according to some embodiments.

In some instances, the UE may not expect said pattern and report this to the base station. Accordingly, if the UE does expect such a pattern, the CRI field in the CSI report may be used to indicate the UE preferred CSI-RS burst. Accordingly, the CSI-RS in different CSI-RS bursts may subject to one or more restrictions. For example, the number of CSI-RS per burst may be the same, the time domain distance may be the same, the frequency domain allocation may be the same, the number of ports may be the same, the QCL assumption may be the same, and/or the time domain pattern (i.e., periodic or semi-persistent or aperiodic) may be the same, according to some embodiments.

In some embodiments, for enhanced CSI reporting involving exploiting channel time domain properties in terms of CMR configuration, it may be necessary to support configuration(s) of bursts of NZP-CSI-RS. For example, additional fields such as repetitionFactor and timeGap may be introduced to respectively correspond to the number of CSI-RS per CSI-RS burst and the time distance between adjacent CSI-RS in the same CSI-RS burst (in units of symbol/slot), according to some embodiments. Additionally or alternatively, these fields may be introduced in CSI-ReportConfig, CSI-ResourceConfig, NZP-CSI-RS-ResourceSet, or NZP-CSI-RS-Resource parameters, according to some embodiments. Accordingly, when the new fields are introduced in one of CSI-ReportConfig, CSI-ResourceConfig, NZP-CSI-RS-ResourceSet, the same configured value may apply to all the associated NZP-CSI-RS-Resources.

In some scenarios, a code block describing how these additional fields may be introduced can be illustrated as follows:

{
NZP-CSI-RS-Resource ::= SEQUENCE {
nzp-CSI-RS-ResourceId NZP-CSI-RS-ResourceId,
resourceMapping CSI-RS-ResourceMapping,
powerControlOffset INTEGER (−8..15),
powerControlOffsetSS ENUMERATED{db−3, db0, db3, db6} OPTIONAL, -- Need R
scramblingID ScramblingId,
periodicityAndOffset CSI-ResourcePeriodicityAndOffset OPTIONAL, -- Cond
PeriodicOrSemiPersistent
qcl-InfoPeriodicCSI-RS TCI-StateId OPTIONAL, -- Cond Periodic
repetitionFactor-r18 INTEGER {2..32}
timeGap-r18 INTEGER {1:28}
...
}

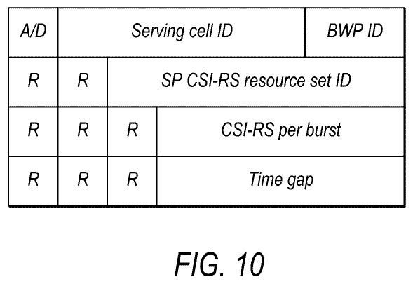

### FIG. 10—MAC-CE for CMR Configuration Modification

FIG. 10 illustrates an example media access control—control element (MAC-CE) format used to specify CSI-RS burst patterns and timing for CMR configurations, according to some embodiments. More specifically, for CSI reporting enhancements (especially involving bursts of NZP-CSI-RS for semi-persistent CSI-RS) exploiting channel time domain properties in terms of CMR configuration, FIG. 10 illustrates an example MAC-CE format which can be used to modify the configuration of one or more CMR bursts.

In some embodiments, the A/D field may correspond to one bit indicating whether to activate or deactivate the corresponding semi-persistent (SP) CSI-RS resource set, the Serving Cell identifier (ID) field may correspond to five bits indicating the ID of the serving cell, and the bandwidth part (BWP) ID field may correspond to two bits indicating the ID of the BWP. Additionally or alternatively, the R field(s) may correspond to a reserved bit for octet alignment, the #CSI-RS per burst field may correspond to five bits indicating the number of CSI-RS per burst in which the bitwidth can be larger or smaller. Furthermore, the Time Gap field may correspond to five bits indicating the number of symbols between adjacent CSI-RS in the same burst in which the bitwidth can be larger or smaller. According to some embodiments, the same MAC-CE may be further enhanced to change configuration of multiple SP CSI-RS resource sets simultaneously. Accordingly, these fields of the MAC-CE may be used to modify the CMR configuration information and more specifically adjust the number of CSI-RS per burst and/or the time domain spacing between adjacent CSI-RS. These adjustments or modifications may be made based on received CSI reports from the UE indicating preferred CMR configurations (e.g., preferred number of CSI-RS per burst and/or the time domain spacing, for example), according to some embodiments.

In some embodiments, it may be further necessary to support configuration of bursts of NZP-CSI-RS for aperiodic CSI-RS. For example, the additional configuration of the number of CSI-RS per burst and time domain distance between two adjacent CSI-RS in the same burst may also be configured during the aperiodic-CSI (AP-CSI) trigger to CSI report association. In other words, the additional configuration of number of CSI-RS per burst and time domain distance between two adjacent CSI-RS in the same burst may be configured in CSI-AssociatedReportConfigInfo. In some scenarios, the number of CSI-RS per burst and time domain distance between two adjacent CSI-RS in the same burst may be configured in CSI-AssociatedReportConfigInfo can be illustrated by a code block as follows:

{
CSI-AssociatedReportConfigInfo ::= SEQUENCE {
reportConfigId CSI-ReportConfigId,
resourcesForChannel CHOICE {
nzp-CSI-RS SEQUENCE {
resourceSet INTEGER (1..maxNrofNZP-CSI-RS-ResourceSetsPerConfig),
repetitionFactor-r18 INTEGER {2..32}
timeGap-r18 INTEGER {1:28}
qcl-info SEQUENCE (SIZE(1..maxNrofAP-CSI-RS-ResourcesPerSet)) OF TCI-StateId
OPTIONAL -- Cond Aperiodic
},
csi-SSB-ResourceSet INTEGER (1..maxNrofCSI-SSB-ResourceSetsPerConfig)
},
csi-IM-ResourcesForInterference INTEGER(1..maxNrofCSI-IM-ResourceSetsPerConfig)
OPTIONAL, -- Cond CSI-IM-ForInterference
nzp-CSI-RS-ResourcesForInterference INTEGER (1..maxNrofNZP-CSI-RS-
ResourceSetsPerConfig) OPTIONAL, -- Cond NZP-CSI-RS-ForInterference
...,
}

According to some embodiments, DCI may be used to configured the number of CSI-RS per burst and time domain distance between two adjacent CSI-RS in the same burst. Moreover, the DCI may be the UL DCI that triggers the AP-CSI reporting, according to some embodiments. Accordingly, one option may be to introduce an additional field in scheduling DCI to dynamically indicate the number of CSI-RS per burst and time domain distance between two adjacent CSI-RS in the same burst, according to some embodiments. According to some scenarios, another option may be to use radio resource control (RRC) signaling to configure a list or table of multiple possible combinations of a number of CSI-RS per burst and time domain and corresponding distances between two adjacent CSI-RS in the same burst. Accordingly, an additional field may be introduced in scheduling DCI to dynamically indicate which combination is selected, as one possible embodiment.

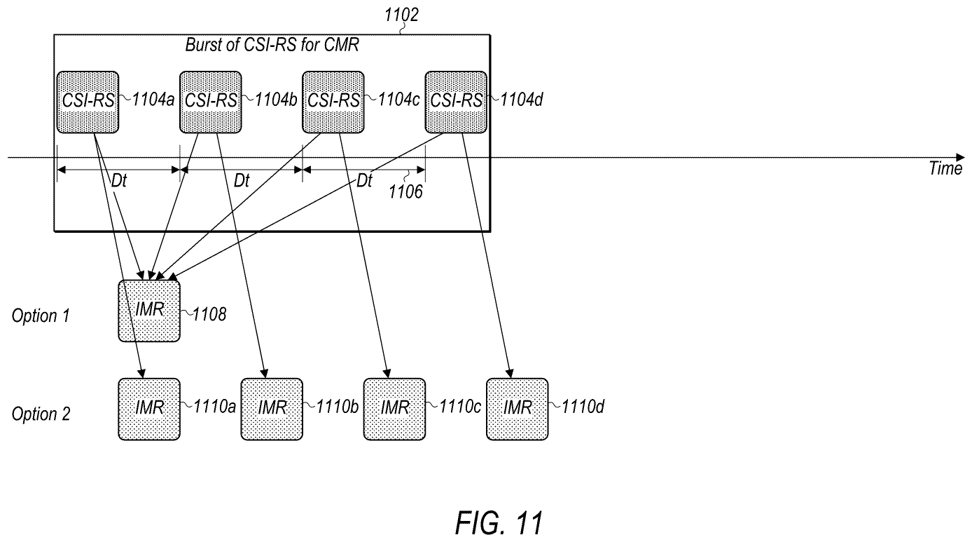

### FIG. 11—CSI-RS Burst Pattern for IMR

FIG. 11 illustrates an example channel state information-reference signal (CSI-RS) burst pattern and timing corresponding to an interference measurement resource (IMR) configuration, according to some embodiments. More specifically, for CSI reporting enhancement exploiting channel time domain properties in terms of IMR configuration, it may be necessary to support when a burst of NZP-CSI-RS is configured for channel measurement.

For example, as illustrated by FIG. 11, a burst of CSI-RS for CMR 1102 may include multiple CSI-RS such as 1104a, 1104b, 1104c, and 1104d, according to some embodiments. Furthermore, each CSI-RS in the burst may be separated equally in time such as Dt 1106. However, it may be possible to have more or less CSI-RS in a burst 1102 or different time domain spacing Dt 1106 depending on the CMR/IMR configuration provided by the base station. Moreover, it may be possible to adjust or modify the number of CSI-RS per burst or time domain spacing 1106 of the burst 1102 as indicated in the CMR/IMR configuration, according to some embodiments.

Moreover and as one possible scenario, all the CMR resources in the same burst (e.g., CSI-RS 1104a-d) may be associated with one IMR resource such as 1108, according to some embodiments. Additionally or alternatively and as a second scenario, each CMR resource in the same burst may be associated with its own IMR resource, according to some embodiments. For example, CMR resource CSI-RS 1104a may be associated with IMR resource 1110a, CMR resource CSI-RS 1104b may be associated with IMR resource 1110b, CMR resource CSI-RS 1104c may be associated with IMR resource 1110c, and CMR resource CSI-RS 1104d may be associated with IMR resource 1110d. Accordingly, for the second scenario, there would be a same number of IMR and CMR resources per burst.

In some embodiments, the first or second scenarios may be different for ZP-IMR (CSI-IM) and NZP-IMR (NZP-CSI-RS). For example, ZP-IMRs or NZP-IMRs may be configured according to either the first or second scenario in which the UE measures for interference with the base station acting in a respectively passive (e.g., (e.g., base station does not provide referential interference signaling on the channel(s)) or active (e.g., base station provides referential interference signaling on the channel(s)) manner.

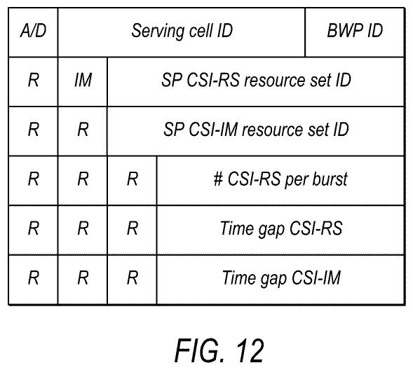

### FIG. 12—MAC-CE for IMR Configuration Modification

FIG. 12 illustrates an example MAC-CE format used to specify CSI-RS burst patterns and timing for IMR configurations, according to some embodiments. More specifically, for CSI reporting enhancement exploiting channel time domain properties in terms of semi-persistent IMR configuration, FIG. 12 illustrates how the fields or parameters of a MAC-CE format may be used to modify the configuration of an IMR burst.

For example, as shown in FIG. 12, the A/D field may correspond to one bit indicating whether to activate or deactivate the corresponding SP CSI-RS resource set, the Serving Cell ID field may correspond to five bits indicating the ID of the serving cell, and the BWP ID field may correspond to two bits indicating the ID of the BWP. Furthermore, the R field may correspond to a reserved bit for octet alignment and the IM field may correspond to whether or not a SP CSI-IM exists. Moreover, the #CSI-RS per burst field may correspond to five bits indicating the number of CSI-RS per burst and whether the same number per burst applies to CSI-IM and the Time Gap CSI-IM field may correspond to five bits indicating the number of symbols between adjacent CSI-IM in the same burst or the same as the number of CMR per burst (i.e., reuse of “Time Gap CSI-RS}).

Additionally or alternatively, the same MAC-CE may be further enhanced to change the configuration of multiple SP CSI-IM resource sets simultaneously, according to some embodiments. Accordingly, these fields of the MAC-CE may be used to modify the IMR configuration information and potentially adjust how ZP-IMR or NZP-IMR resources are associated with the number of CSI-RS in a burst. These adjustments or modifications may be made based on received CSI reports from the UE indicating preferred IMR configurations, according to some embodiments. For example, the UE may indicate a preferred time gap for CSI-IM resources in a CSI report and the base station may accordingly utilize a MAC-CE to modify the IMR configuration to accommodate this preference. Additionally or alternatively, the UE may indicate a preference of how IMR resources are associated with the CMR resources (e.g., CSI-RS). For example, the UE may indicate a preference for one IMR to be associated with all the CSI-RS (e.g., the first scenario discussed in reference to FIG. 11) or a preference for each CMR to be associated with a different IMR (e.g., the second scenario discussed in reference to FIG. 11), according to some embodiments.

In some embodiments, it may be necessary to support configurations of bursts of IMR for aperiodic IMR. As one possibility, the additional configuration of number of IMR per burst and time domain distance between two adjacent IMR in the same burst may also be configured during the AP-CSI trigger to CSI report association (i.e., in CSI-AssociatedReportConfigInfo). Moreover, the same configuration as CMR may be used or an independent configuration for IMR may be possible. In some scenarios, a code block describing how this may be configured in CSI-AssociatedReportConfigInfo can be illustrated as follows:

{
CSI-AssociatedReportConfigInfo ::= SEQUENCE {
reportConfigId CSI-ReportConfigId,
resourcesForChannel CHOICE {
nzp-CSI-RS SEQUENCE {
resourceSet INTEGER (1..maxNrofNZP-CSI-RS-ResourceSetsPerConfig),
repetitionFactorCMR-r18 INTEGER {2..32}
timeGapCMR-r18 INTEGER {1:28}
qcl-info SEQUENCE (SIZE(1..maxNrofAP-CSI-RS-ResourcesPerSet)) OF TCI-StateId
OPTIONAL -- Cond Aperiodic
},
csi-SSB-ResourceSet INTEGER (1..maxNrofCSI-SSB-ResourceSetsPerConfig)
},
csi-IM-ResourcesForInterference INTEGER(1..maxNrofCSI-IM-ResourceSetsPerConfig)
OPTIONAL, -- Cond CSI-IM-ForInterference
nzp-CSI-RS-ResourcesForInterference INTEGER (1..maxNrofNZP-CSI-RS-
ResourceSetsPerConfig) OPTIONAL, -- Cond NZP-CSI-RS-
repetitionFactorIMR-r18 INTEGER {2..32}
timeGapIMR-r18 INTEGER {1:28}
ForInterference
...,
}

Note that while various embodiments described herein may relate to 5G/NR, they may be extended to any set of wireless communication, including LTE, GSM, CDMA, etc.

Still another example embodiment may include a device, comprising: an antenna; a radio coupled to the antenna; and a processing element operably coupled to the radio, wherein the device is configured to implement any or all parts of the preceding examples.

Yet another example embodiment may include a method, comprising: by a device: performing any or all parts of the preceding examples.

A still further example embodiment may include a computer program comprising instructions for performing any or all parts of any of the preceding examples.

A yet further example embodiment may include an apparatus comprising means for performing any or all of the elements of any of the preceding examples.

Still another example embodiment may include an apparatus comprising a processing element configured to cause a wireless device to perform any or all of the elements of any of the preceding examples.

Embodiments of the present disclosure may be realized in any of various forms. For example, some embodiments may be realized as a computer-implemented method, a computer-readable memory medium, or a computer system. Other embodiments may be realized using one or more custom-designed hardware devices such as ASICs. Still other embodiments may be realized using one or more programmable hardware elements such as FPGAs.

In some embodiments, a non-transitory computer-readable memory medium may be configured so that it stores program instructions and/or data, where the program instructions, if executed by a computer system, cause the computer system to perform a method, e.g., any of the method embodiments described herein, or, any combination of the method embodiments described herein, or, any subset of any of the method embodiments described herein, or, any combination of such subsets.

In some embodiments, a device (e.g., a UE 106 or BS 102) may be configured to include a processor (or a set of processors) and a memory medium, where the memory medium stores program instructions, where the processor is configured to read and execute the program instructions from the memory medium, where the program instructions are executable to implement any of the various method embodiments described herein (or, any combination of the method embodiments described herein, or, any subset of any of the method embodiments described herein, or, any combination of such subsets). The device may be realized in any of various forms.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

Although the embodiments above have been described in considerable detail, numerous variations and modifications will become apparent to those skilled in the art once the above disclosure is fully appreciated. It is intended that the following claims be interpreted to embrace all such variations and modifications.

1. A method, comprising:
establishing, via a cellular network, a cellular link with a user equipment (UE);
transmitting, to the UE, radio resource control (RRC) signaling including channel state information (CSI) reporting configuration information;
transmitting, according to the CSI reporting configuration information, at least one burst of one or more CSI reference signals (CSI-RS) to the UE;
receiving, from the UE, a first CSI report according to the CSI reporting configuration information, wherein the first CSI report uses time-domain properties of the channel corresponding to the burst of the one or more CSI-RS;
determining, based on the first CSI report, modified CSI reporting configuration information;
transmitting, to the UE, the modified CSI reporting configuration information;
transmitting, according to the modified CSI reporting configuration information, an adjusted burst of one or more additional CSI-RS to the UE; and
receiving, from the UE, an additional CSI report according to the modified CSI reporting configuration information.

2. The method of claim 1, wherein the CSI reporting configuration information comprises at least one of a number of CSI-RS per burst or time domain spacing of the one or more CSI-RS.

3. The method of claim 1, further comprising:
modifying the CSI reporting configuration information via a media access control—control element (MAC-CE).

4. The method of claim 1, wherein the one or more CSI-RS are transmitted according to at least one of the following:
the one or more CSI-RS are equally spaced in a time-domain;
the one or more CSI-RS have the same frequency domain allocation;
the one or more CSI-RS have the same number of antenna ports;
the one or more CSI-RS are quasi-colocated (QCL);
the one or more CSI-RS share a time-domain pattern; or
the one or more CSI-RS have a same periodicity.

5. The method of claim 1, further comprising:
transmitting, to the UE, an additional burst comprising one or more additional CSI-RS, wherein the one or more additional CSI-RS are transmitted in a non-overlapping manner with the one or more CSI-RS.

6. The method of claim 1, wherein the first CSI report comprises an indication of one or more preferred channel measurement resource (CMR) or interference measurement resources (IMR) configurations.

7. The method of claim 1, further comprising:
transmitting, to the UE, downlink control information (DCI), wherein the DCI comprises at least one of a number of CSI-RS per burst or time domain spacing information corresponding to the burst of the one or more CSI-RS.

8. The method of claim 1, wherein the one or more CSI-RS are associated with one or more interference measurement resources (IMRs).

9. The method of claim 8, further comprising:
transmitting, to the UE, downlink control information (DCI), wherein the DCI comprises time-domain information corresponding to the burst of the one or more IMRs.

10. The method of claim 1, wherein the additional CSI report comprises an additional indication of one or more preferred channel measurement resource (CMR) or interference measurement resources (IMR) configurations.

11. The method of claim 1, wherein at least one of the first CSI report or additional CSI report comprises Doppler shift or Doppler spread measurement information.

12. A method, comprising:
establishing, via a cellular network, a cellular link with a base station (BS);
receiving, from the BS, radio resource control (RRC) signaling including channel state information (CSI) reporting configuration information;
receiving, according to the CSI reporting configuration information, at least one burst of one or more CSI reference signals (CSI-RS) from the BS; and
transmitting, to the BS, a first CSI report according to the CSI reporting configuration, wherein the first CSI report uses time-domain properties of the channel corresponding to the burst of the one or more CSI-RS.
receiving, from the BS, modified CSI reporting configuration information;
receiving, according to the modified CSI reporting configuration information, an adjusted burst of one or more additional CSI-RS from the BS; and
transmitting, to the BS, an additional CSI report according to the modified CSI reporting configuration information.

13. The method of claim 12, wherein the CSI reporting configuration information comprises at least one of a number of CSI-RS per burst or time domain spacing of the one or more CSI-RS.

14. The method of claim 12, wherein the one or more CSI-RS are transmitted according to at least one of the following:
the one or more CSI-RS are equally spaced in a time-domain;
the one or more CSI-RS have the same frequency domain allocation;
the one or more CSI-RS have the same number of antenna ports;
the one or more CSI-RS are quasi-colocated (QCL);
the one or more CSI-RS share a time-domain pattern; or
the one or more CSI-RS have a same periodicity.

15. The method of claim 12, further comprising:
receiving, from the BS, an additional burst comprising one or more additional CSI-RS, wherein the one or more additional CSI-RS are transmitted in a non-overlapping manner with the one or CSI-RS.

16. The method of claim 12, wherein the first CSI report comprises an indication of at least one of one or more preferred channel measurement resource (CMR) or one or more interference measurement resources (IMR) configurations.

17. The method of claim 12, further comprising:
receiving, from the BS, downlink control information (DCI), wherein the DCI comprises at least one of a number of CSI-RS per burst or time domain spacing information corresponding to the burst of the one or more CSI-RS.

18-20. (canceled)

21. An apparatus, comprising:
a processor configured to, when executing instructions stored a memory, perform operations comprising:
establishing, via a cellular network, a cellular link with a user equipment (UE);
transmitting, to the UE, radio resource control (RRC) signaling including channel state information (CSI) reporting configuration information;
transmitting, according to the CSI reporting configuration information, at least one burst of one or more CSI reference signals (CSI-RS) to the UE;
receiving, from the UE, a first CSI report according to the CSI reporting configuration information, wherein the first CSI report uses time-domain properties of the channel corresponding to the burst of the one or more CSI-RS;
determining, based on the first CSI report, modified CSI reporting configuration information;
transmitting, to the UE, the modified CSI reporting configuration information;
transmitting, according to the modified CSI reporting configuration information, an adjusted burst of one or more additional CSI-RS to the UE; and
receiving, from the UE, an additional CSI report according to the modified CSI reporting configuration information.

22. The apparatus of claim 21, wherein the CSI reporting configuration information comprises at least one of a number of CSI-RS per burst or time domain spacing of the one or more CSI-RS.

23. The apparatus of claim 21, further comprising:
a radio operably coupled to the processor.
